(19) United States
(12) Patent Application Publication
(10) Pub. No.: US 2026/0330696 A1
(43) Pub. Date: Oct. 22, 2026

(54) METHODS AND SYSTEMS FOR IMAGE COMPRESSION WITH MACHINE LEARNING

(71) Applicant: INNOPEAK TECHNOLOGY, INC., Palo Alto, CA (US)

(72) Inventor: Jenhao HSIAO, Palo Alto, CA (US)

(73) Assignee: INNOPEAK TECHNOLOGY, INC., Palo Alto, CA (US)

(21) Appl. No.: 19/112,867

(22) PCT Filed: Dec. 15, 2022
(86) PCT No.: PCT/US2022/053087

§ 371 Date: Mar. 18, 2025

(51) Int. Cl. G06T 9/00; G06N 3/0464; G06N 3/08; G06T 3/4046

(52) U.S. Cl. CPC G06T 9/002; G06N 3/0464; G06N 3/08; G06T 3/4046

(57) ABSTRACT

A method for encoding a compressed image is provided, including accessing an input image characterized by a first file size; dividing the input image into h×w regions according to a predetermined sequence; generating spatial codes using the h×w regions and a first convolutional neural network, the spatial codes being associated with a first code dimension; accessing a visual codebook, the visual codebook comprises K visual tokens; performing quantization by matching the spatial codes against the K visual tokens; generating a compressed image comprising h×w matched visual tokens, the compressed image being characterized by a second size, the second size being less than a tenth of the first file size; and storing the compressed image. A method for decoding the compressed image represented by the visual tokens is also provided to reconstruct the image with minimum loss of information.

### BACKGROUND OF THE INVENTION

Lately, the demand for image compression has increased dramatically to cope with the enormous number of high-resolution images produced by mobile devices. Traditional image compression methods, such as JPEG, JPEG2000, BPG, and VVC, follow the transform coding paradigm with carefully designed linear transforms and coding tools, to effectively address practical image compression. Encoding is block-based and iterative. Rate-distortion is optimized during encoding by exhaustively searching optimal block partitions and coding and prediction modes. Complexity can be controlled by limiting the range of coding and prediction modes or using heuristics. The rate can be estimated from previous blocks and controlled by adjusting quantization parameters.

Conventional compression standards are handcrafted pipelines that rely on manual tuning, which requires extensive expertise and is extremely time-consuming. These schemes transform the input image into compressed coefficients, apply quantization to prune the least informative bits, and entropy encode the quantized coefficients into bitstream files. Moreover, some hybrid techniques have been developed, which apply learned image restoration methods to remove undesirable artifacts from images reconstructed by conventional codecs. Nonetheless, such hybrid methods still suffer from blocking effects and cannot be jointly optimized via the automated process, which hampers the development of more sophisticated architectures.

Therefore, new and improved image compression methods and systems are desired.

### BRIEF SUMMARY OF THE INVENTION

The present invention is directed to image processing methods and systems. In a specific embodiment, the present invention provides an image encoding method. An image is divided into a number of regions. These regions are encoded into spatial codes in a code dimension by a convolutional neural network. The spatial codes are quantized into visual tokens using a visual codebook. There are other embodiments as well.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for encoding a compressed image. The method also includes accessing an input image characterized by a first file size. The method also includes dividing the input image into h×w regions according to a predetermined sequence. The method also includes generating spatial codes using the h×w regions and a first convolutional neural network, the spatial codes being associated with a first code dimension. The method also includes accessing a visual codebook, the visual codebook may include K visual tokens. The method also includes performing quantization by matching the spatial codes against the K visual tokens. The method also includes generating a compressed image including h×w matched visual tokens. The compressed image is characterized by a second file size. The second file size is less than a tenth of the first file size. The method also includes storing the compressed image. Other embodiments of this aspect include corresponding computer systems, apparatus, and computer programs recorded on one or more computer storage devices, each configured to perform the actions of the methods.

Implementations may include one or more of the following features. The method may include performing downsampling the h×w regions by a predetermined factor using a second convolutional neural network. The downsampling is associated with a second code dimension. The method may include downsampling the spatial codes using a second convolutional neural network at a second code dimension. The number of visual tokens K is greater than 1000. The visual codebook is stored at a static memory. The visual codebook is embedded in a hardware encoder device. Implementations of the described techniques may include hardware, a method or process, or computer software on a computer-accessible medium.

One general aspect includes a method for decoding a compressed image. The method also includes accessing a compressed image. The compressed image includes h×w visual tokens arranged according to a predetermined sequence. The h×w visual tokens are associated with a first code dimension. The method also includes decoding the visual tokens to generate h×w regions using a diffusion decoder. The method also includes determining global interrelation values among the h×w regions. The method also includes generating an intermediate image by arranging the h×w regions. The method also includes modifying adjacent h×w regions using at least the global interrelation values. The method also includes constructing an output image using at least the intermediate image. The method also includes storing the output image. Other embodiments of this aspect include corresponding computer systems, apparatus, and computer programs recorded on one or more computer storage devices, each configured to perform the actions of the methods.

Implementations may include one or more of the following features. The method may include iteratively refining the intermediate image. The diffusion decoder may include denoising autoencoders. The diffusion decoder is configured to perform Markovian diffusion process. The method may include generating the output image by denoising the intermediate image using at least the h×w visual tokens. The method may include displaying the output image. Implementations of the described techniques may include hardware, a method or process, or computer software on a computer-accessible medium.

One general aspect includes a system for image compression. The system also includes an interface configured to receive an input image, the input image being characterized by a first file size. The system also includes a data storage coupled to the processor. The data storage is configured to store the visual codebook, the visual codebook may include K visual tokens. The system also includes a memory. The system also includes a processor coupled to the data storage and the memory. The processor is configured to: access the input image; divide the input image into h×w regions according to a predetermined sequence; generate spatial codes using the h×w regions; access the storage to obtain the visual codebook; perform quantization by matching the spatial codes against the K visual tokens; generate a compressed image may include h×w matched visual tokens, the compressed image being characterized by a second file size, the second file size being less than the first file size; and store the compressed image at the memory. Other embodiments of this aspect include corresponding computer systems, apparatus, and computer programs recorded on one or more computer storage devices, each configured to perform the actions of the methods.

Implementations may include one or more of the following features. The system where the processor may include a neural processing unit (NPU) and/or a graphics processing unit (GPU). The processor may include a central processing unit (CPU). The visual codebook is embedded in the processor. The visual codebook is trained using a deep learning process. The processor is further configured to perform downsampling of the h×w region by a predetermined factor. The system may include a hardware encoder, the visual codebook being embedded in the hardware encoder. Implementations of the described techniques may include hardware, a method or process, or computer software on a computer-accessible medium.

It is to be appreciated that embodiments of the present invention provide many advantages over conventional techniques. Among other things, the present invention provides a neural image compression method that employs autoencoders to model the compression and reconstruction process as a unified task and optimize the rate-distortion trade-off jointly. Additionally, unlike the conventional methods that represent an image with pixels, this invention encodes an image as a quantized composition of perceptually rich image constituents from a visual codebook, which dramatically reduces the requirement for storage space. Furthermore, a diffusion decoder is trained to efficiently model the global interrelations within images and reconstruct the image from the quantized composition of rich image constituents with minimal information losses. The image compression method proposed in this invention can thus achieve more than 10 times higher compression rate than conventional methods while maintaining outstanding image quality. Depending on the application, embodiments of the present invention can be implemented using general processors and/or specialized encoders. There are other embodiments as well.

The present invention achieves these benefits and others in the context of known technology. However, a further understanding of the nature and advantages of the present invention may be realized by reference to the latter portions of the specification and attached drawings.

### BRIEF DESCRIPTION OF THE DRAWINGS

FIG. 1 is a simplified block diagram illustrating a system 100 for image compression according to embodiments of the present invention.

FIG. 2A is a simplified block diagram illustrating a mechanism 200 for image encoding according to embodiments of the present invention.

FIG. 2B is a simplified block diagram illustrating a mechanism 250 for image decoding to embodiments of the present invention.

FIG. 3 is a flow diagram illustrating a method 300 for encoding a compressed image according to embodiments of the present invention.

FIG. 4 is a flow diagram illustrating a method 400 for decoding a compressed image according to embodiments of the present invention.

FIG. 5 is a simplified diagram illustrating an image enhancement mechanism used in decoding processes according to embodiments of the present invention.

### DETAILED DESCRIPTION OF THE INVENTION

The present invention is directed to image processing methods and systems. In a specific embodiment, the present invention provides an image encoding method. An image is divided into a number of regions. These regions are encoded into spatial codes in a code dimension by a convolutional neural network. The spatial codes are quantized into visual tokens using a visual codebook. There are other embodiments as well.

In some embodiments, a novel neural image compression method is proposed to employ autoencoders to model the compression and reconstruction process as a unified task and optimize the rate-distortion trade-off jointly. In contrast to conventional methods that represent an image with pixels, in an encoding stage, an image is modeled as a compressed image file containing a finite number of compositions of perceptually rich image constituents from a visual codebook, which dramatically reduces the requirement of storage space. The visual codebook is separately obtained through a machine-learning process that involves millions of images. Each perceptually rich image constituent is described as a unique visual token. By limiting the total number of visual tokens, the compressed image file is much smaller in file size than conventional ones and can be stored with substantial memory saving. In a decoding stage, a diffusion decoder is trained within the neural network to efficiently model the global interrelations within images and reconstruct the image using the compressed image file with minimal information losses. Experiments demonstrate superior performance in terms of compression rate and reconstructed image quality comparing to conventional methods.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

Please note, if used, the labels left, right, front, back, top, bottom, forward, reverse, clockwise, and counterclockwise have been used for convenience purposes only and are not intended to imply any particular fixed direction. Instead, they are used to reflect relative locations and/or directions between various portions of an object.

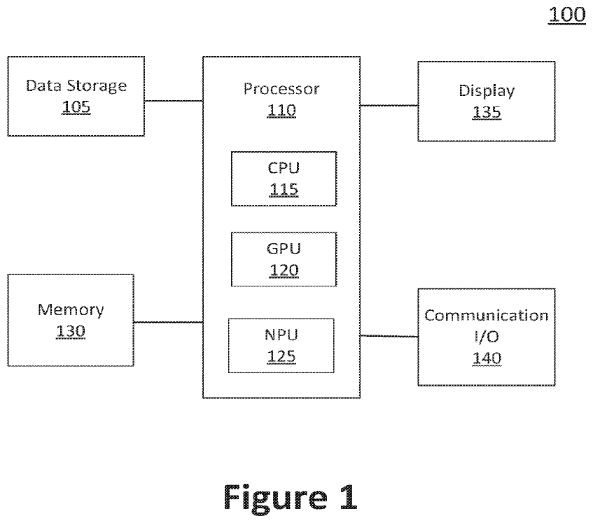

FIG. 1 is a simplified block diagram illustrating a system 100 for image compression according to the embodiments of the present invention. This diagram is merely an example, which should not unduly limit the scope of the claims. One of ordinary skill in the art would recognize many variations, alternatives, and modifications. System 100 for image compression includes a processor 110 configured to be connected to a data storage device 105, and memory 130. System 100 includes a communication interface 140, which is configured to receive an input image. System 100 may include display device 135 for optionally displaying the input image in various optional modes from low-resolution user avatars all the way through 8K resolutioncomputer desktop wallpapers. Optionally, the input image may be captured by a digital camera and saved in the data storage device 105. Optionally, the input image may be uploaded from data storage device 105, or downloaded from a cloud computer or internet via the communication interface 140. The processor 110 includes at least one of a central processing unit (CPU) 115, a neural processing unit (NPU) 125, and/or a graphics processing unit (GPU) 120.

In a specific embodiment, system 100 includes an encoder configured to perform autoencoding under neural network machine learning with convolutional segmentation function to convert the input image into a plurality of feature maps or spatial regions. For example, the encoder may be implemented using processor 110. In some embodiments, one or more hardware modules may be configured to implement the encoder. The encoder is configured to perform a downsampling function including rate-reduction or bandwidth reduction during the feature region generation. Optionally, the downsampling provides decimation characterized by a predetermined factor. In yet another embodiment, the processor 110 includes a diffusion encoder configured for neural image compression involving latent representation learning (LRL) that attempts to infer latent variables from empirical measurements. For example, the encoder understands the global composition of images, enabling it to generate locally realistic as well as globally consistent patterns. The encoder is configured in a convolutional neural network (CNN) involving deep learning applied to analyze visual images. For example, CNN processes are performed by NPU 125.

In a specific embodiment, the processor 110 also includes a quantizer configured to use a composition of perceptually rich image constituents from a visual codebook to represent the plurality of feature maps as a set of quantized latent intermediate elements called visual tokens. The visual codebook is obtained through a machine learning process in a CNN that is trained involving millions of images. The visual codebook simply is comprised of a composition of visual words or image constituents (or referred as “visual tokens” in this specification), each of which is a learned representation identified by the machine learning process, to describe an image. The size of the visual codebook can be huge for achieving the best quality of image description. It also can be as small as slightly greater than 1000 for substantially reducing process time with the highest rate of compression while still maintaining outstanding image quality. Optionally, the visual codebook can be saved in static memory or embedded in a hardware form of the encoder (in CPU, NPU, or GPU) in processor 110 so that the memory space in memory 130 can be saved. The set of visual tokens is saved in memory 130 as essential basic elements to form a compressed image file with a much smaller file size than the conventional one which is described at pixel level. By learning (within the neural-network supported autoencoder) an effective code, the total number of the visual tokens in the compressed image file needed for describing the input image can be set to a relatively small number to significantly reduce the storage space. The encoding visual tokens can also be directly used as input data of a decoder in processor 110 for reconstructing the image.

In various implementations, processor 110 implements a diffusion decoder configured to employ a diffusion model to conduct the token-to-image translation task. The diffusion model is built using a CNN to help learning global interrelations within images and reconstruct the image with minimal information losses compared to the original input image. In particular, the diffusion decoder also can be embedded in the NPU or CPU/GPU as an equally weighted sequence of denoising autoencoders. The denoising autoencoders can be trained via a machine learning process in the CNN to efficiently model their global interrelations within images and use the previously encoded set of visual tokens as input data to reconstruct a target image with minimal information losses compared to the original image. Essentially, the compression process and reconstruction process are executed in processor 110 as a unified task with rate-distortion tradeoff being optimized jointly.

In some embodiments, neural network processing unit (NPU) 125 adopts a data-driven parallel computing architecture and is particularly good at processing massive multimedia data such as video and images. NPU is more efficient for encoding than the traditional CPU/GPU. For example, the NPU processor includes modules for multiplication and addition used to calculate matrix multiplication and addition, convolution, dot product, and other functions in a CNN.

In some embodiments, the system 100 can be implemented in any computer, mobile device, VR device, or server used in cloud storage. Images captured in smartphones, or all kinds of digital cameras have to be sent over the internet in huge batches (e.g., Instagram feeds or Facebook pages). A huge number of images also have to get to users really quickly since people typically refuse to wait for more than a second for a web page to load. Finally, video files are basically made up of thousands of images that have to be sent over the web in real time. Effective image compression methods and embedded systems can provide significant help with and fundamental solution to the above challenges.

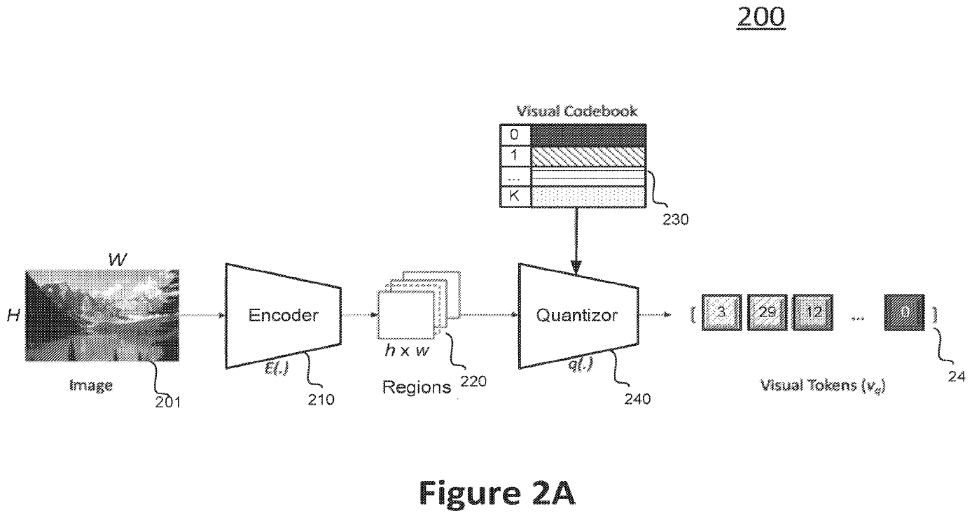

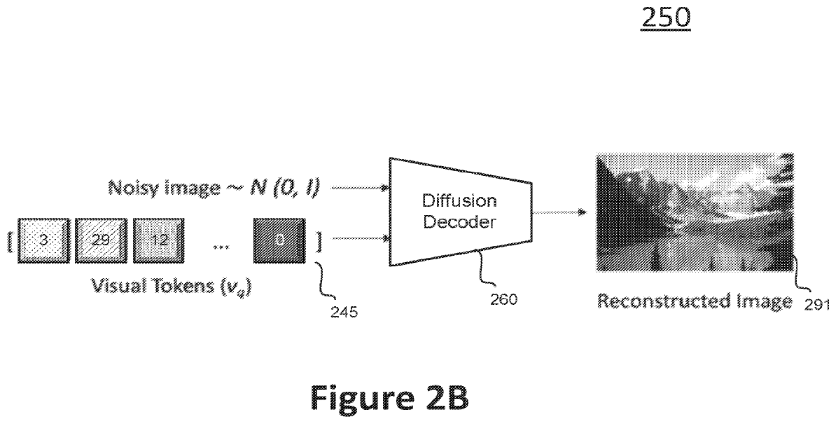

FIG. 2A is a simplified block diagram illustrating a mechanism 200 for image encoding according to the embodiments of the present invention. This diagram is merely an example, which should not unduly limit the scope of the claims. One of ordinary skill in the art would recognize many variations, alternatives, and modifications. As an example, mechanism 200 for image encoding starts with image 201. For example, image 201 is simply a photo image in digitized form saved in a data storage device. As shown in FIG. 2A, mechanism 200 for image encoding is enabled with a diffusion autoencoder for neural image compression. Neural image compression uses a model that understands the global composition of images, enabling it to generate locally realistic as well as globally consistent patterns. In an embodiment, mechanism 200 includes an encoding operation 210 of encoder E(⋅) configured as a diffusion autoencoder for neural image compression. Operation 210 of encoder E(⋅) leads to a convolutional transformation of the original image 201 to generate a latent intermediate file containing a set of regions 220. Instead of being represented by traditional pixels, the regions 220 are represented by a composition of perceptually rich image codes, or spatial codes, drawn from code entries of a visual codebook 230. For example, spatial codes are in CNN dimensions. The visual codebook 230 is made of a set of image constituents (denoted by, 0, 1, 2, . . . K) called visual tokens determined or learned through a machine learning process involving millions of training images. The visual codebook 230 used here can be pre-trained offline or stored directly in a static memory embedded in hardware environment for implementing mechanism 200.

In a specific implementation, the mechanism 200 for image encoding can be applied to an image x, aiming to represent the image x∈R^{H×W×3} by a spatial collection of visual tokens 245, instead of by traditional pixels over the physical image size of height H and width W with 3 color codes. Firstly, mechanism 200 for image encoding executes an encoding operation 210 E(x) to perform a convolutional transformation of the image x to generate a latent representation v=E(x)∈R^{h×w×n}^{ᵥ}. This step involves a plurality of machine learning processes to make the encoder E(⋅) an autoencoder during the convolutional transformation. Optionally, this step is performed using a first convolutional neural network associated with the encoder. Secondly, the operation 210 of the encoder E(x) also includes a downsampling function with a downsampling factor d (e.g., h=H/d, w=W/d). Thus, the original image x is divided into h×w regions. The latent representation v can be represented as a group of spatial codes corresponding to the h×w regions 220, and each region is represented by a spatial code vᵢⱼ∈Rⁿ^{ᵥ}. Optionally, this step is performed using a second convolutional neural network associated with the encoder. Finally, the mechanism 200 for image encoding executes a quantization operation 240 of quantizor q(⋅) to map the spatial codes corresponding to the respect h×w regions 220 to the group of visual tokens 245 by looking up code entries v_{q} ∈R^{h×w×n}^{ᵥ} the visual codebook 230, nᵥ is the code dimension. Thus, the group of visual tokens 245 can be saved as a compressed file in a memory device associated with mechanism 200 for image encoding. The compressed file is associated with a compression rate comparing to the original image x.

The visual codebook 230 can be acquired by an offline clustering process and saved in the memory of the hardware device associated with the encoder for implementing mechanism 200. Using an algorithm like k-means, the latent features z can be learned offline from a training image set in a convolutional neural network, and grouped into K template code entries vₖ i.e., visual tokens, to build the visual codebook

$$V ∈ {\{ ν \}}_{k = 1}^{K} .$$

K is called a size of visual codebook 230. Visual codebook 230 obtained offline can be stored directly in a static memory embedded in hardware environment for implementing mechanism 200.

In the final step mentioned above, the quantization operation 240 of quantizor q(v) performs a subsequent element-wise quantization of each spatial code vᵢⱼ∈Rⁿᵥ in each feature region 220 onto its closest code entry vₖ selected from the visual codebook 230. The quantization operation 240 can be expressed as:

v_{q}=q(v):=(argminᵥ_{^{∈}}v∥vᵢⱼ−vₖ∥)∈R^{h×w×n}^{ᵥ}

where

$$V ∈ {\{ v \}}_{k = 1}^{K}$$

is the discrete visual codebook with K visual codes. As the result, the original image 201, after the encoding operation 210 of the encoder E(⋅) and the quantization operation 240 of the quantizor q(⋅), is compressed into a sequence of visual tokens v_{q} 245 that have h×w visual codebook indices corresponding to the respective closest code entries in the visual codebook 230. In some embodiments, the mechanism 200 for image encoding can be embedded in a hardware encoder within an NPU/CPU/GPU processor or the like. Optionally, the size of the visual codebook K can be set as a parameter adjustable for different image compression applications. In an embodiment, K can be set to as small as 1024 or can be much larger than 15000. A larger-sized visual codebook has more visual tokens for mapping the spatial code of each feature region to the corresponding visual token during the quantization operation of the encoding mechanism 200 for image compression, the resulting compressed file of the original image 201 represented by the more visual tokens is more accurate, but the tradeoff is less in corresponding compression rate and a larger compressed file.

FIG. 2B is a simplified block diagram illustrating a mechanism 250 for image decoding to embodiments of the present invention. This diagram is merely an example, which should not unduly limit the scope of the claims. One of ordinary skill in the art would recognize many variations, alternatives, and modifications. Mechanism 250 for image decoding is directly associated with mechanism 200 for image decoding shown in FIG. 2A. As shown in FIG. 2B, mechanism 250 for image decoding executes a decoding operation 260 of the decoder using the group of visual tokens 245 as one input data. The decoder is a diffusion decoder configured to conduct the token-to-image translation task, unlike previous work that relied on a CNN decoder to directly reverse the latent code. The diffusion model helps to learn global interrelations within images and reconstruct the image with minimal information losses.

In an embodiment, the diffusion model is a probabilistic model designed to learn a data distribution p(x) by gradually denoising a normally distributed variable, which corresponds to learning a reverse process of a fixed Markov Chain of length T. In a specific embodiment, given a dataset of input-output pairs, denoted as

$$D = {\{ {v}_{qi} , {x}_{i} \}}_{i = 1}^{N} ,$$

which represent samples drawn from an unknown conditional distribution p(x|v_{q}), a noisy image x_{T} is generated. Also, a neural network f_{θ} is trained to denoise x_{T} when the diffusion decoder is operated to restore the original image x given the group of visual tokens v_{q} 245 as the input data. Optionally, the denoising decoding process is conducted using a third convolutional neural network associated with the decoder. In other words, the noisy image x_{T} is used as another input data for the decoding operation 260 of the diffusion decoder.

In a specific embodiment, a conditional Denoising Diffusion Probabilistic Model is used to generate a predicted target image x₀ in T refinement steps. Starting with a pure noise image x_{T}~N (0, I) (Gaussian distributions), the model iteratively refines the image through successive iterations (x_{T-1}|x_{T-2}, . . . , x₀) according to learned conditional transition distributions p₀ (xₜ₋₁|xₜ, v_{q}) such that the reconstructed image x₀ 291 is nearly the same as the original image x 201 (see FIG. 2A), x₀≈x.

In another specific embodiment, the diffusion decoder based on mechanism 250 for image decoding can be interpreted as an equally weighted sequence of denoising autoencoders

$${f}_{θ} ( {x}_{t} , {v}_{q}^{t} , t ) ; t = 1 … T ,$$

which are trained to predict a denoised variant of their input xₜ conditioning on visual token v_{q}. The corresponding objective can be simplified to

$${L}_{d m} = {E}_{x , ε \sim N ( 0 , 1 ) , t} [ {‖ ε - {f}_{θ} ( {x}_{t} , {v}_{q}^{t} , t ) ‖}_{2}^{2} ]$$

with t uniformly sampled from {1, . . . , T}, where ε~N (0, 1) is the noise added in the forward Markovian diffusion process. In other words, the loss of image information will be minimized compared with the original image 201 when the target reconstructed image 291 is determined based on the input of the group of visual tokens 245. In some embodiments, the mechanism 250 for image decoding can be embedded in a hardware decoder within an NPU processor or the like.

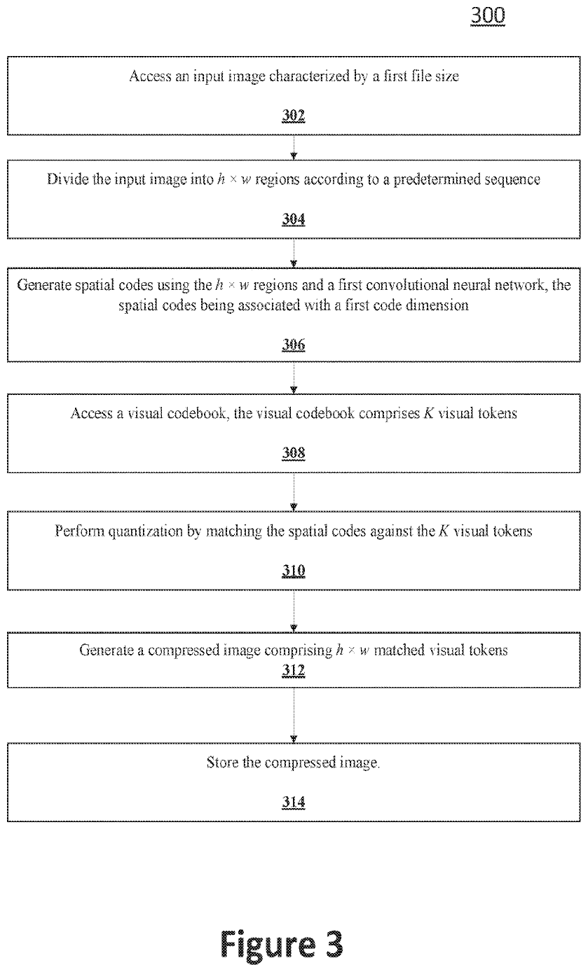

FIG. 3 is a flow diagram illustrating a method 300 for encoding a compressed image according to the embodiments of the present invention. This diagram is merely an example, which should not unduly limit the scope of the claims. One of ordinary skill in the art would recognize many variations, alternatives, and modifications. For example, one or more steps may be added, removed, repeated, modified, replaced, rearranged, and/or overlapped, and they should not limit the scope of claims.

In an embodiment, method 300 is implemented in mechanism 200 for image encoding described in FIG. 2A. At step 302, the method includes accessing an input image characterized by a first file size. Typically, the first file size is described by the 2D pixel matrix covering the image height H, width W, with 3 color codes. The input image may be captured directly by a camera or a phone and stored in its data storage chip. Optionally, the input image may be stored in a storage device of a computer, or downloaded from a cloud data center, or from social networks on the internet. The step allows the input image to be directly read from the storage chip or downloaded from the cloud or uploaded from the user's phone.

At step 304, the method includes dividing the input image into h×w regions according to a predetermined sequence. Optionally, each region is a square shape. The dividing operation includes a downsampling transformation involving a decimation calculation associated with a downsampling factor d (e.g., h=H/d, w=W/d).

At step 306, the method further includes generating spatial codes using the h×w regions and a first convolutional neural network. The spatial codes are associated with a first code dimension. The step of generating the spatial codes for the h×w regions includes a machine learning process in the first convolutional neural network so the spatial codes are learned through various convolutional transformations of the h×w regions. The spatial codes are denoted by vᵢⱼ to represent the h×w regions. Optionally, the downsampling transformation is performed using a second convolutional neural network associated with the encoder. The downsampling is associated with a second code dimension for the spatial codes.

At step 308, the method additionally includes accessing a visual codebook having K visual tokens. The visual codebook is predetermined or trained offline using millions of training images to determine or summarize a group of K basic image constituents (i.e., visual tokens). Optionally, the visual codebook has been saved in a static memory or embedded in a hardware encoder device configured to implement method 300. The number K can be as small as 1024 or much larger than 15000 for providing sufficient unique visual tokens for representing an image or its feature region.

At step 310, method 300 also includes performing quantization by matching the spatial codes against the K visual tokens. The step allows each spatial code to be compared with all entries in the visual codebook accessed in step 308 and is mapped to the closest one of the K visual tokens.

At step 312, method 300 includes generating a compressed image including h×w visual tokens. Each of the h×w visual tokens is matched with a spatial code in step 310.

The compressed image, comparing to the original input image, is associated with a compression rate. At step 314, the method executes storing the compressed image in a memory ready for the next decoding process depending on the applications. Since the compression rate achieved by method 300 for the compressed image is much higher than known conventional methods, memory space is saved substantially, making the encoding method for image compression a much less expensive one for large-scale applications such as smartphones or PUDs as well as for cloud computing.

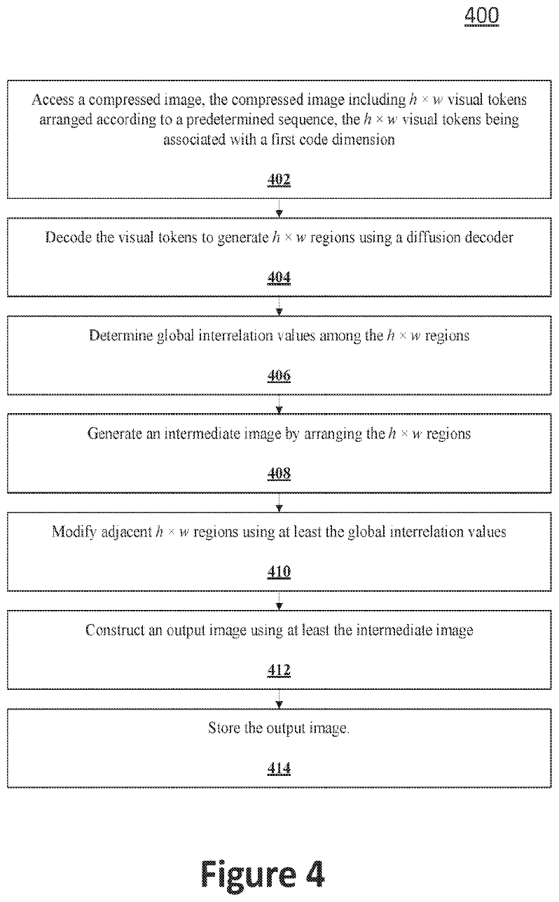

FIG. 4 is a flow diagram illustrating a method 400 for decoding a compressed image according to the embodiments of the present invention. This diagram is merely an example, which should not unduly limit the scope of the claims. One of ordinary skill in the art would recognize many variations, alternatives, and modifications. Method 400 for decoding a compressed image is associated with mechanism 250 for image decoding described in FIG. 2B. As shown in FIG. 4, at step 402, the compressed image that is obtained by method 300 can be accessed for decoding. This compressed image is represented by h×w visual tokens arranged according to a predetermined sequence. Specifically, the h×w visual tokens are associated with a first code dimension. The compressed file may be saved in a static memory and can be directly read by the decoder implemented for executing method 400.

At step 404, method 400 includes decoding the visual tokens to generate h×w regions using a diffusion decoder. The diffusion decoder is built based on a probabilistic model designed to learn a data distribution p(x) by gradually denoising a normally distributed variable, which corresponds to learning the reverse process of a fixed Markov Chain of length T. The probabilistic model is created in a convolutional neural network in which the diffusion decoder learns global interrelations within images and reconstructs the image with minimal information losses. The diffusion decoder takes the h×w visual tokens from step 402 as one input data and a set of noise images with Gaussian distributions as another input data.

At step 406, method 400 includes determining global interrelation values among the h×w regions obtained in step 404. Starting with a first noisy version of Gaussian x_{T}~N (0, I) and the given visual tokens in a conditional Denoising Diffusion Probabilistic Model to determine the global interrelation values among the h×w regions at this step.

At step 408, method 400 additionally includes generating an intermediate image x_{T-1} by arranging the h×w regions. Further, at step 410, method 400 includes modifying adjacent h×w regions (in terms of their visual codes) using at least the global interrelation values obtained in the previous step. This includes a learning process through which any misaligned lines between adjacent regions of the h×w regions can be reconnected.

At step 412, method 400 includes constructing an output image using at least the intermediate image. This includes successive iterations in T refinement steps, the diffusion decoder is able to determine each next refined noisy image until the target image x₀ is generated as the output image. This makes the diffusion decoder an autoencoder learned in a convolutional neural network.

At step 414, method 400 includes storing the output image. The output image is a reconstructed image with minimum information loss comparing to the original image. The output image can be stored on any data storage device such as a handheld computer or a cloud computer connected to the decoder. Optionally, the output image can be displayed on a display device coupled with the hardware decoder, a processor, a computer terminal, or a phone screen.

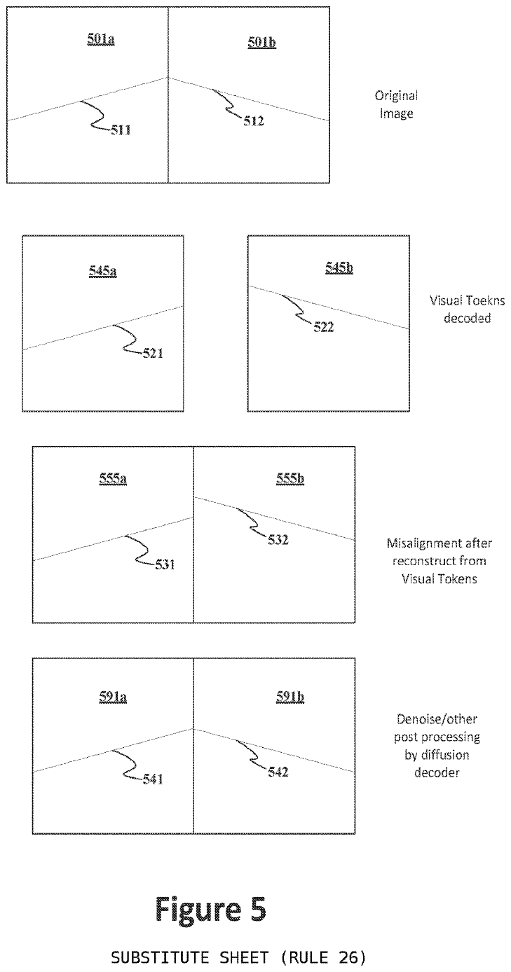

FIG. 5 is a simplified diagram illustrating an image enhancement mechanism used in decoding processes according to embodiments of the present invention. This diagram is merely an example, which should not unduly limit the scope of the claims. One of ordinary skill in the art would recognize many variations, alternatives, and modifications. As shown, the top part of the figure shows two adjacent regions 501a and 501b of an original image. Schematically, region 501a includes feature line 511, and the adjacent region 501b includes another feature line 512. Feature line 511 is perfectly aligned with the feature line 512 at the boundary between the two regions. After performing the image encoding using method 300 described above, the two regions are respectively transformed or represented by two visual tokens 545a and 545b, shown in the next-to-top part of the figure. Schematically, the visual token 545a retains a corresponding feature line 521 and the visual token 545b retains a corresponding feature line 522. The feature line 521/522 may be different from the feature line 511/512 though certain key features are retained respectively. After being reconstructed in an intermediate image from the visual tokens (e.g., using method 400), the next-to-bottom part of the figure shows that the visual token 545a and visual token 555b are arranged to become two adjacent regions 555a and 555b of the intermediate image. The region 555a includes a feature line 531 inherited from the feature line 521 in the visual token 545a and the region 555b also includes a feature line 532 inherited from the feature line 522 in the visual token 545b. Depending on the refinement level of the intermediate image, the two feature lines 531 and 532 may not be in good alignment with each other. This misalignment introduces noise or loss-of-information during the decoding process compared to the original information. In the bottom part of the figure, two adjacent regions of the output image, 591a and 591b, each with respective feature lines 541 and 542 that are re-aligned at the boundary. By letting the diffusion decoder learn through multiple iterative refinement steps in a neural network under method 400, the diffusion decoder is able to perform a denoise and other post-processing when generating each level of intermediate images during the sequential refinement steps until the output image is generated with the misalignment issue removed by the diffusion decoder.

In general, an image size can be computed in bytes as follows

size=width×height×3 (RGB),

if the metadata are ignored. Here, width and height are the dimensions of the image in pixels, and RGB stands for the 3 channels that each represents a component of the color data. These are numbers from 0-255 and are usually the most popular way of encoding the colors of an image. Hence, for a common 4K image, the size will be

4000 pixels×3000 pixels×3 channels≈36.0 MB,

which is a very large amount. A JPEG compressed image for such an image would need, averagely, 3 MB, which is still a non-negligible size.

Table 1 shows the required storage spaces for a 4000×3000 image based on the diffusion autoencoder proposed in the current disclosure, and it shows a dramatical space saving with minimal quality losses. For example, with downsampling factor d=16 and K=1024, a high compression ratio of 1:51 and 1:615 can be achieved comparing to the most popular JPEG algorithm and raw image respectively.

TABLE 1
Storage saving based on the method for encoding
and decoding with machining learning (d =
Down-sampling factor, K = Number of visual tokens)

| | Storage | | Compression | Compression |
|---|---|---|---|---|
| | Requirement | | Ratio | Ratio |
| | (present | | against | against |
| Configuration | disclosure) | | Raw | JPEG |
| d = 16, K = 1024 | 58.5 | KB | 1:615 | 1:51 |
| d = 16, K = 16384 | 82.0 | KB | 1:439 | 1:36 |
| d = 8, K = 1024 | 234 | KB | 1:153 | 1:12 |
| d = 8, K = 16384 | 328 | KB | 1:109 | 1:9 |

Despite the high compression rate, the present invention can deliver high-quality re-generated images. While the above is a full description of the specific embodiments, various modifications, alternative constructions and equivalents may be used. Therefore, the above description and illustrations should not be taken as limiting the scope of the present invention which is defined by the appended claims.

What is claimed is:

1. A method for encoding a compressed image, the method comprising:
accessing an input image characterized by a first file size;
dividing the input image into h×w regions according to a predetermined sequence;
generating spatial codes using the h×w regions and a first convolutional neural network, the spatial codes being associated with a first code dimension;
accessing a visual codebook, the visual codebook comprises K visual tokens;
performing quantization by matching the spatial codes against the K visual tokens;
generating a compressed image comprising h×w matched visual tokens, the compressed image being characterized by a second size, the second size being less than a tenth of the first file size; and
storing the compressed image.

2. The method of claim 1 further comprising performing downsampling for the h×w regions by a predetermined factor using a second convolutional neural network.

3. The method of claim 2 wherein the downsampling is associated with a second code dimension.

4. The method of claim 1 further comprising downsampling the spatial codes using a second convolutional neural network at a second code dimension.

5. The method of claim 1 wherein K is greater than 1000.

6. The method of claim 1 wherein the visual codebook is stored at a static memory.

7. The method of claim 1 wherein the visual codebook is embedded in a hardware encoder device.

8. A method for decoding a compressed image, the method comprising:
accessing a compressed image, the compressed image including h×w visual tokens arranged according to a predetermined sequence, the h×w visual tokens being associated with a first code dimension;
decoding the visual tokens to generate h×w regions using a diffusion decoder;
determining global interrelation values among the h×w regions;
generating an intermediate image by arranging the h×w regions;
modifying adjacent h×w regions using at least the global interrelation values;
constructing an output image using at least the intermediate image; and
storing the output image.

9. The method of claim 8 further comprising iteratively refining the intermediate image.

10. The method of claim 9 further wherein the diffusion decoder comprises denoising autoencoders.

11. The method of claim 8 further wherein the diffusion decoder is configured to perform Markovian diffusion process.

12. The method of claim 8 further comprising generating the output image by denoising the intermediate image using at least the h×w visual tokens.

13. The method of claim 8 further comprising displaying the output image.

14. A system for image compression, the system comprising:
an interface configured to receive an input image, the input image being characterized by a first file size;
a data storage configured to store a visual codebook, the visual codebook comprising K visual tokens; and
a memory;
a processor coupled to the data storage and the memory, the processor being configured to:
access the input image;
divide the input image into h×w regions according to a predetermined sequence;
generate spatial codes using the h×w regions;
access the storage to obtain the visual codebook;
perform quantization by matching the spatial codes against the K visual tokens;
generate a compressed image comprising h×w matched visual tokens, the compressed image being characterized by a second file size, the second file size being less than the first file size; and
store the compressed image at the memory.

15. The system of claim 14 wherein the processor comprises a neural processing unit (NPU) and/or a graphics processing unit (GPU).

16. The system of claim 14 wherein the processor comprises a central processing unit (CPU).

17. The system of claim 14 wherein the visual codebook is embedded in the processor.

18. The system of claim 14 wherein the visual codebook is trained using a deep learning process.

19. The system of claim 14 wherein the processor is further configured to perform downsampling for the h×w region by a predetermined factor.

20. The system of claim 14 further comprising a hardware encoder, the visual codebook being embedded in the hardware encoder.
